(19) United States
(12) Patent Application Publication
(10) Pub. No.: US 2013/0329928 A1
(43) Pub. Date: Dec. 12, 2013

(54) TELEVISION RECEIVER AND ELECTRONIC APPARATUS

(71) Applicant: KABUSHI KAISHA TOSHIBA, Tokyo (JP)

(72) Inventors: Toshio Ooe, Tokyo (JP); Noriyoshi Murakami, Kanagawa (JP)

(73) Assignee: KABUSHI KAISHA TOSHIBA, Tokyo (JP)

(21) Appl. No.: 13/967,552

(22) Filed: Aug. 15, 2013

Related U.S. Application Data
(63) Continuation of application No. PCT/JP2013/058196, filed on Mar. 14, 2013.

(30) Foreign Application Priority Data
Apr. 27, 2012 (JP) 2012-103760

(51) Int. Cl. H04R 1/02

(52) U.S. Cl. CPC H04R 1/028
USPC 381/333

(57) ABSTRACT

According to one embodiment, a television receiver includes: a housing comprising a first opening; a speaker configured to be housed in the housing at a position where the speaker is exposed through the first opening; a cover comprising a plurality of second openings, the cover configured to be fixed to the housing on the first opening to cover the speaker; and a contact member in contact with the cover and configured to cover a part of the second openings.

### CROSS-REFERENCE TO RELATED APPLICATIONS

This application is a continuation of PCT international application Ser. No. PCT/JP2013/058196, filed Mar. 14, 2013, which designates the United States, incorporated herein by reference, and which is based upon and claims the benefit of priority from Japanese Patent Application No. 2012-103760, filed on Apr. 27, 2012, the entire contents of which are incorporated herein by reference.

### FIELD

Embodiments described herein relate generally to a television receiver, and an electronic apparatus.

### BACKGROUND

Conventionally, there is known an electronic apparatus comprising a housing provided with an opening through which sound output from a housed speaker is let out, and a net-formed cover that is provided on the opening to cover the speaker.

In this kind of electronic device such as a television receiver, it is desirable to prevent the occurrence of noises from a cover that covers a speaker.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary front elevation of an example of a television receiver according to a first embodiment;

FIG. 2 is an exemplary side view of an example of the television receiver in the first embodiment;

FIG. 3 is an exemplary front elevation of an example of apart of the television receiver in the first embodiment;

FIG. 4 is an exemplary view in the direction of the arrow F4 of FIG. 3;

FIG. 5 is an exemplary sectional view taken from line F5-F5 of FIG. 3;

FIG. 6 is an exemplary front elevation of an example of apart of a television receiver according to a first modification of the first embodiment;

FIG. 7 is an exemplary sectional view taken from line F7-F7 of FIG. 6;

FIG. 8 is an exemplary front elevation of an example of apart of a television receiver according to a second modification of the first embodiment, in which a cover is at a close position;

FIG. 9 is an exemplary front elevation of an example of the part of the television receiver in the second modification of the first embodiment, in which the cover is at an open position;

FIG. 10 is an exemplary sectional view taken from line F10-F10 of FIG. 8;

FIG. 11 is an exemplary sectional view taken from line F11-F11 of FIG. 9;

FIG. 12 is an exemplary sectional view of an example of apart of a television receiver according to a third modification of the first embodiment, in which a cover is at a close position;

FIG. 13 is an exemplary sectional view of an example of the part of the television receiver in the third modification of the first embodiment, in which the cover is at an open position;

FIG. 14 is an exemplary perspective view of an example of an electronic apparatus according to a second embodiment;

FIG. 15 is an exemplary perspective view of an example of a part of the electronic apparatus in the second embodiment;

FIG. 16 is an exemplary view in the direction of the arrow F16 of FIG. 15;

FIG. 17 is an exemplary perspective view of an example of a part of the internal structure of the electronic apparatus in the second embodiment;

FIG. 18 is an exemplary perspective view of an example of a part of the internal structure of the electronic apparatus in the second embodiment; and

FIG. 19 is an exemplary perspective view of an example of a speaker of the electronic apparatus in the second embodiment.

### DETAILED DESCRIPTION

In general, according to one embodiment, a television receiver comprises: a housing comprising a first opening; a speaker configured to be housed in the housing at a position where the speaker is exposed through the first opening; a cover comprising a plurality of second openings, the cover configured to be fixed to the housing on the first opening to cover the speaker; and a contact member in contact with the cover and configured to cover a part of the second openings.

A plurality of exemplary embodiments and modifications, which will be described below, comprise the same components. In the following, the same components are represented with common symbols, and the repetition of explanation is partially omitted. Parts in each of the embodiments and the modifications can be substituted by the corresponding parts in the other embodiments and modifications.

The following embodiments exemplify cases in which an electronic apparatus is constituted as a television receiver or a personal computer. However, the electronic apparatuses in the embodiments are not limited thereto. The electronic apparatuses in the embodiments can be constituted as various electronic apparatuses such as a smartphone, a smartbook, a mobile phone, a personal digital assistant (PDA), an image display device, a videophone, an image display controller, or an information recorder.

### First Embodiment

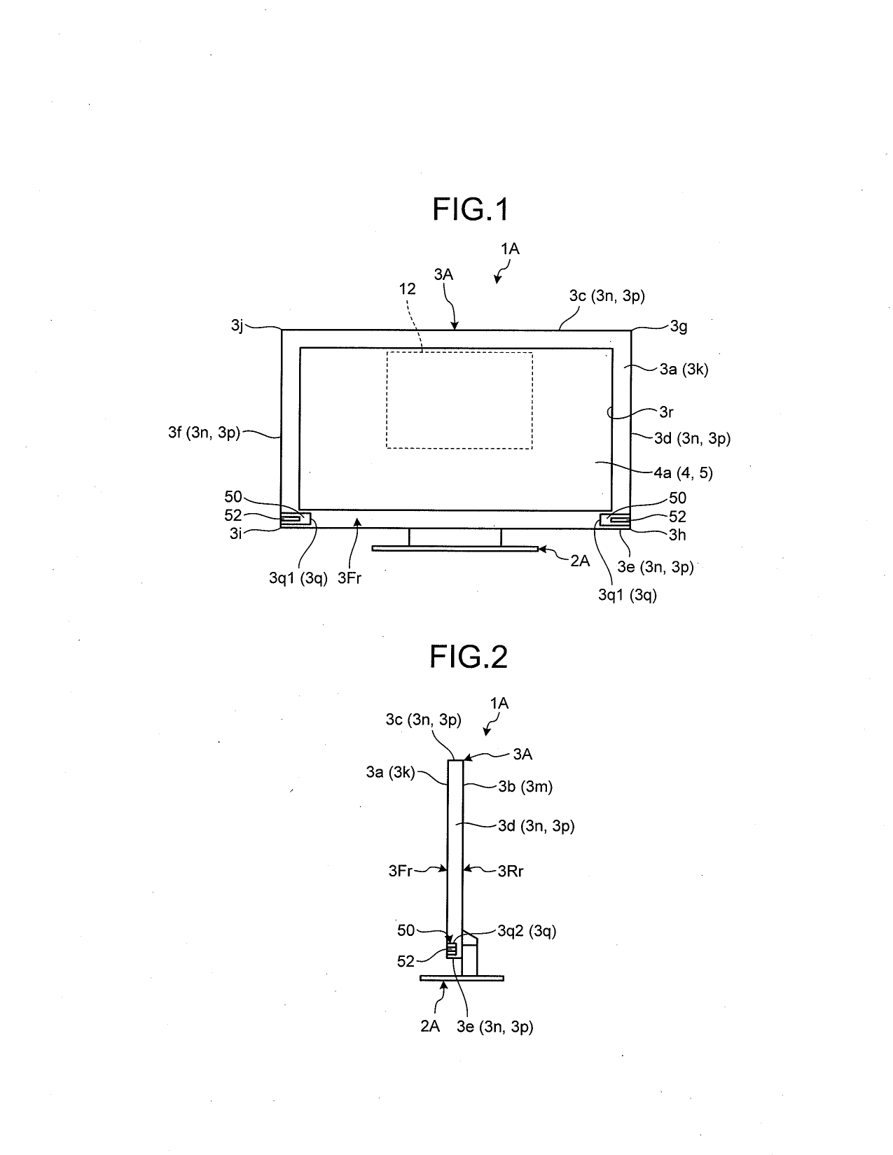

In the first embodiment, as an example, a television receiver 1A that is an example of the electronic apparatus comprises a support portion 2A (a support, a base, a stand), and a housing 3A, as illustrated in FIGS. 1 and 2. To be more specific, the support portion 2A is placed on a carrying portion (a carrying face) (not shown) of a desk, a shelf, a base, etc., to support the housing 3A so that the housing 3A stands. The support portion 2A may support the housing 3A in a fixed manner, or in a movable (rotatable, slidable) manner. The form of motion (rotation) of the housing 3A relative to the support portion 2A is of tilt, pivot, or swivel, for example.

In the first embodiment, as an example, the housing 3A is rectangular (oblong as an example in the first embodiment) in a front view and a rear view, as illustrated in FIG. 1. As illustrated in FIG. 2, the housing 3A is thin flat rectangular parallelepiped in a front-back direction (a thickness direction of the housing 3A). The housing 3A has a face 3a (a facies anterior, a front face, a face portion), and the opposite face 3b (a rear face, a back face, a face portion). The face 3a and the face 3b are nearly parallel (parallel as an example in the first embodiment). As illustrated in FIG. 1, the housing 3A has four ends 3c to 3f (sides, edges), and four corners 3g to 3j (apexes, curves, ends) in a front view. The ends 3c and 3e are examples of long sides, while the ends 3d and 3f are examples of short sides. The housing 3A can function as a housing portion for housing parts, and also as a support for supporting heavy objects (a display device 4, parts, etc.), for example.

The housing 3A has a wall 3k (a portion, a plate, a frame, a front wall, a surface wall, a top wall) having the face 3a, and a wall 3m (a portion, a plate, a back wall, a rear wall, a bottom wall) having the face 3b. The walls 3k and 3m are rectangular (oblong as an example in the first embodiment). The wall 3k has a frame form, and the wall 3m has a plate form. The housing 3A has four walls 3n (portions, plates, side walls, end walls, standing walls, extending portions) that have a face 3p (a side face, a peripheral face) extending between the wall 3k and the wall 3m. A rectangular opening 3r is provided on the wall 3k.

The housing 3A is constituted by a combination of a plurality of parts (split bodies, parts). As an example, the housing 3A comprises a first member 3Fr (a first portion, a front-side member, a cover, a bezel, a frame) having at least the wall 3k, and a second member 3Rr (a second portion, a back-side member, a base, a bottom, a plate, a cover) having at least the wall 3m. In the first embodiment, as an example, the walls 3n are constituted as a part of the second member 3Rr. Separately from the first member 3Fr and the second member 3Rr, the housing 3A can comprise a third member (a third portion, an intermediate member, an inner, a middle frame, a middle plate) (not shown). A part of the third member can constitute a part of the walls 3k, 3m, and 3n. The first member 3Fr, the second member 3Rr, and the third member, for example can be individually formed of metallic, synthetic resin, or other material.

In the first embodiment, as an example, the housing 3A houses the display device 4 (a display portion, a display, a panel, a display part). To be more specific, a display screen 4a positioned on the side of the face 3a of the display device 4 is exposed to the front side (outside) of the housing 3A through the opening 3r. A user can visually recognize the display screen 4a through the opening 3r from the front side. The display device 4 is rectangular (oblong as an example in the first embodiment) in a front view. The display device 4 is thin flat rectangular parallelepiped in a front-back direction. The display device 4 is a liquid crystal display (LCD), an organic electro-luminescent display (GELD), or a plasma display panel (PDP), for example.

In the first embodiment, as an example, on the front side (the surface side, the side of the wall 3k) of the display device 4, a transparent relatively-thin rectangular input operation panel 5 (a touch panel, a touch sensor, an operation face, an input operation portion, an input receiving portion, for example) is provided. The input operation panel 5 covers the display screen 4a. An operator (a user, for example) touches, pushes, rubs the input operation panel 5 with a finger or a stylus, etc., or moves a finger or a stylus, etc., in the vicinity of the input operation panel 5, for example, so as to perform input processing. The light emitted from the display screen 4a of the display device 4 passes through the input operation panel 5, and is then let out to the front side (outside) of the housing 3A through the opening 3r on the wall 3k. The input operation panel 5 is an example of an input module. In the first embodiment, as an example, the display device 4 and the input operation panel 5 are fixed to (supported by) one of the first member 3Fr, the second member 3Rr, and the third member with fixtures (fixing components, metal fittings (screws, metal fittings, or parts, for example)) (not shown) or with an adhesive joint (adhesives, or a double sided tape, for example) (not shown).

In the first embodiment, as an example, the housing 3A houses, on the back side (the reverse side, the rear side, the side of the rear wall, the side opposite to the display screen 4a) of the display device 4, one or more boards 12 (a circuit board, a control board, a main board, an electrical part, a first electrical part), as illustrated in FIG. 1. The board 12 is provided in parallel with the display device 4. The board 12 is spaced from the walls 3k, 3m, 3n, etc., that is, the board 12 is arranged with space (gaps) from the walls 3k, 3m, 3n, etc.

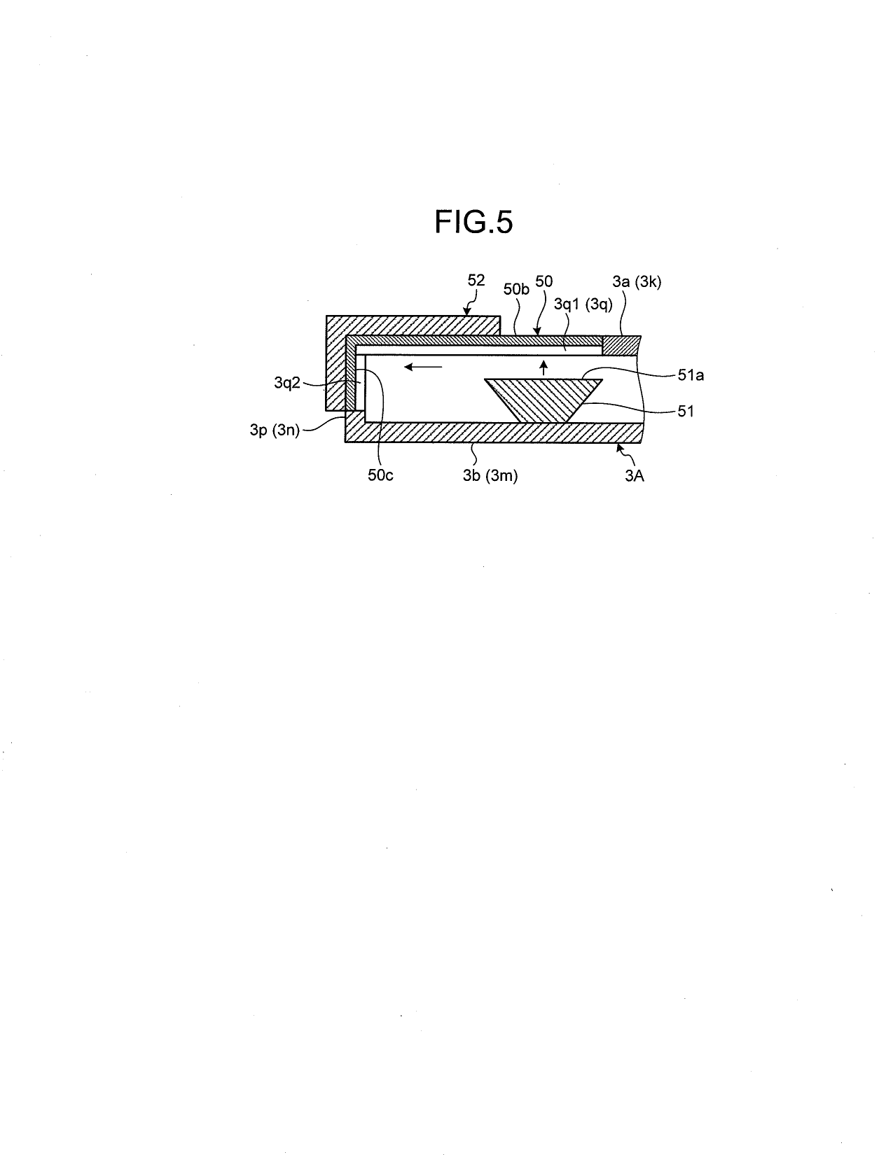

In the first embodiment, as an example, a plurality of parts (not shown) such as a central processing unit (CPU), a graphic controller, power circuit parts, a platform controller hub (PCH), a memory slot connector, an LCD connector, an input/output (I/O) connector, a power coil, an element, and a connector, can be mounted on the board 12. A control circuit can comprise an image signal processing circuit, a tuner, a high-definition multimedia interface (HDMI) signal processor, an audio video (AV) input terminal, a remote control signal receiving module, a controller, a selector, an on-screen display interface, a memory (a read only memory (ROM), a random access memory (RAM), a hard disk drive (HDD), or a solid state drive (SSD), for example), a voice signal processing circuit, etc. The control circuit controls the output of images (moving images, still images, etc.) on the display screen 4a of the display device 4, the output of voice from a speaker 51 (see FIG. 5), the emission of light from a light emitting diode (LED) (not shown), etc. The display device 4, the speaker 51, and the LED are examples of an output module.

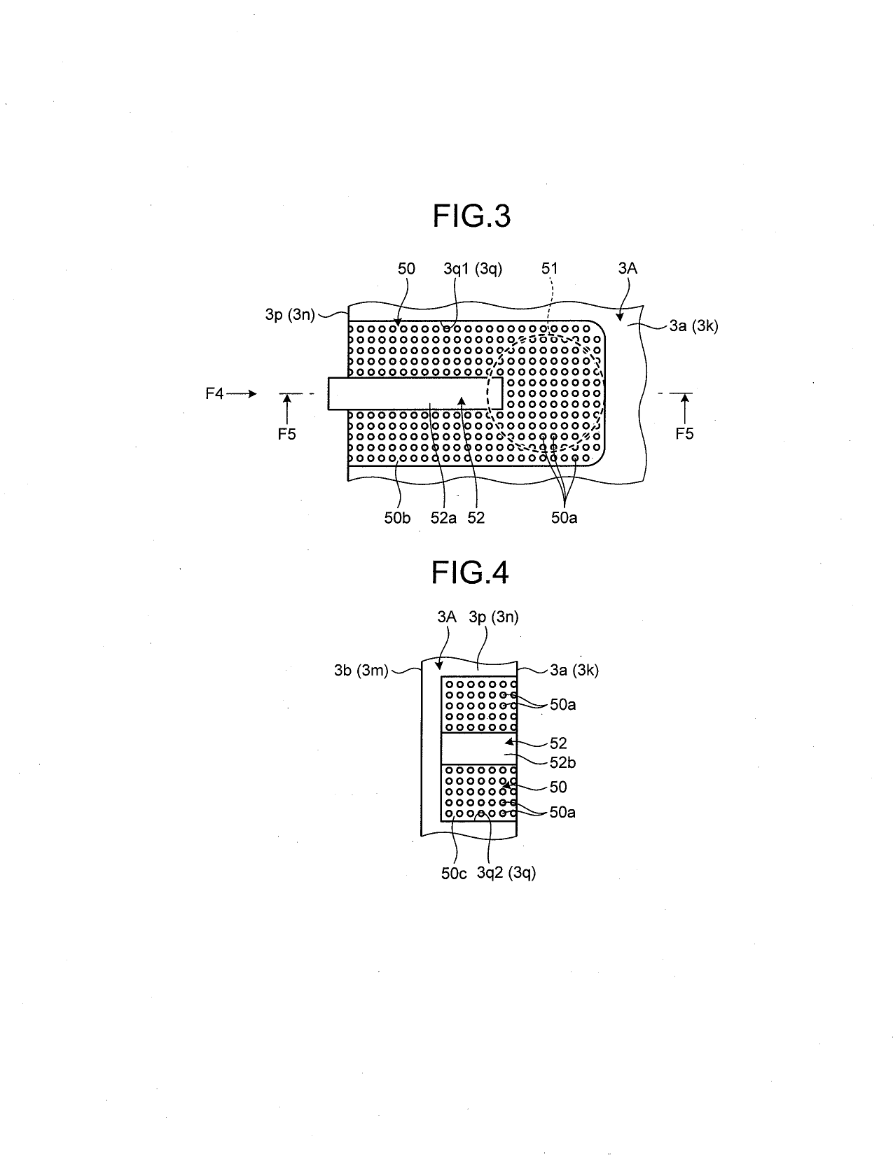

As illustrated in FIGS. 1 and 3, the wall 3k is provided with a left-and-right pair of openings 3q. The opening 3q is an example of the first opening. Two openings 3q are provided in a longitudinal direction of the display screen 4a with mutual space. On each of the openings 3q, a cover 50 having a plurality of openings 50a is provided. The opening 50a is an example of the second opening. Behind the area at which the opening 3q (the covers 50) is provided, the speaker 51 (see FIG. 5, a housed part) is provided, and voice (sound, a sound wave) emitted from a sound emitting portion 51a (a sound emitting face, an emitting portion, an emitting face) of the speaker 51 is let out (output) through the opening 3q (the openings 50a of the cover 50).

To be more specific, as illustrated in FIG. 1 to FIG. 5, the opening 3q is provided so as to extend between the wall 3k and the wall 3n. Thus, the opening 3q has a first portion 3q1 (a portion) provided on the wall 3k, and a second portion 3q2 (a portion) provided on the wall 3n. Here, the wall 3k is an example of the first wall, and the wall 3n is an example of the second wall connected, at an angle, to the wall 3k (a first wall).

The speaker 51 is housed in the housing 3A at a position at which the speaker 51 is exposed through the opening 3q. As an example, the speaker 51 is housed in the housing 3A at a position at which the speaker 51 is exposed through the first portion 3q1 of the opening 3q. In the speaker 51, the sound emitting portion 51a faces the first portion 3q1 of the opening 3q. The speaker 51 is fixed onto the wall 3m, as an example. The speaker 51 emits sound to the outside of the housing 3A through the openings 3q.

The covers 50 are constituted as a schematic net-formed plate, for example. The covers 50 have a schematic L-form. The covers 50 are provided on the openings 3q. As an example, at least a part of the cover 50 is positioned in the opening 3q. The covers 50 are fixed onto the housing 3A by adhesion, welding, or other method. To be more specific, the cover 50 has a plate portion 50b (a first portion, a first plate portion, a wall), and a plate portion 50c (a second portion, a second plate portion, a wall) bended relative to the plate portion 50b. The plate portion 50b is positioned on the wall 3k. The plate portion 50b is provided on the first portion 3q1 of the opening 3q, and is fixed onto the wall 3k. The plate portion 50c is connected, at an angle, to the plate portion 50b, and positioned on the wall 3n. The plate portion 50c is provided on the second portion 3q2 of the opening 3q, and is fixed onto the wall 3n. That is, the covering member 50 is arranged so as to extend between the wall 3k and the wall 3n.

The cover 50 covers the speaker 51. To be more specific, the plate portion 50b faces the sound emitting portion 51a of the speaker 51. The cover 50 is provided with the opening 50a entirely (over the entire area). In other words, each of the plate portions 50b and 50c is provided with the openings 50a. The cover 50 can be formed of metal, or resin, for example.

The cover 50 is provided with a contact member 52 (a part, a member). The contact member 52 has a form along the cover 50. That is, the contact member 52 is constituted by a schematic L-form plate. To be more specific, the contact member 52 has a plate portion 52a (a first portion) provided in contact with the plate portion 50b, and a plate portion 52b provided in contact with the plate portion 50c. At least a part of the contact member 52 is positioned on the side of the cover 50 opposite to the speaker 51. The contact member 52 is provided in contact with the cover 50 so as to cover a part of the openings 50a. In the first embodiment, the opening 50a is provided on the covering member 50 including an area at which the contact member 52 is provided (an area that overlaps with the contact member 52). However, the embodiment is not limited thereto, and the opening 50a may not be provided on the area. The contact member 52 is fixed onto the cover 50 by caulking, adhesion, welding, or other method. A logo or the like may be put on the surface of the contact member 52.

As described above, in the first embodiment, as an example, the contact member 52 is arranged in contact with the cover 50. Therefore, in the first embodiment, as an example, the weight of the contact member 52 affects the cover 50, which prevents (restricts) the vibration of the cover 50. Thus, as an example, the contact member 52 prevents a case in which sound (a sound wave) emitted from the speaker 51 is transmitted to the cover 50 and the cover 50 vibrates due to the influence of the sound. Consequently, it is possible to prevent the occurrence of noises such as chattering noises due to vibration of the cover 50.

In the first embodiment, the opening 3q is provided so as to extend between the wall 3k and the wall 3n. In addition, the cover 50 is provided so as to extend between the wall 3k and the wall 3n. Then, regarding the cover 50, each of the plate portions 50b and 50c is provided with the openings 50a. Therefore, in the first embodiment, the sound emitted from the speaker 51 is let out to the outside (the front side) of the wall 3k and the outside (the front side) of the wall 3n. Then, since the contact member 52 is arranged in contact with the plate portions 50b and 50c, it is possible to prevent the occurrence of noises such as chattering noises due to vibration of the cover 50. Here, the contact member 52 guides the sound emitted from the speaker 51 to the second portion 3q2 of the opening 3q. Thus, the sound can be favorably emitted to the outside (the front side) of the wall 3n. The arrows in FIG. 5 schematically indicate a sound transmission direction.

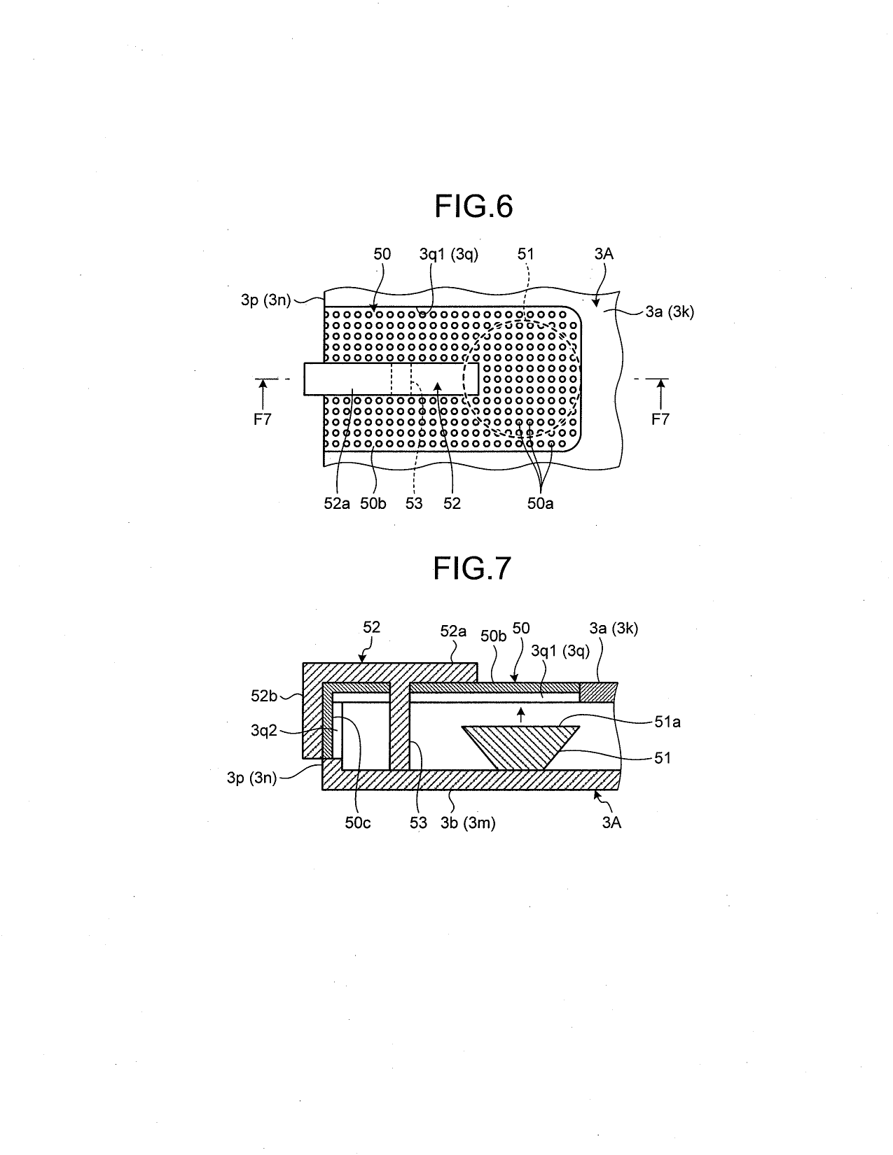

Next, the first modification of the first embodiment will be described with reference to FIG. 6 and FIG. 7. In the first modification, the contact member 52 is fixed onto the housing 3A. As an example, the plate portion 52a of the contact member 52 is fixed onto the wall 3m of the housing 3A with a connecting member 53. The connecting member 53 is formed integrally with the plate portion 52a, for example. The connecting member 53 is fixed on the wall 3m by adhesion, welding, or other method.

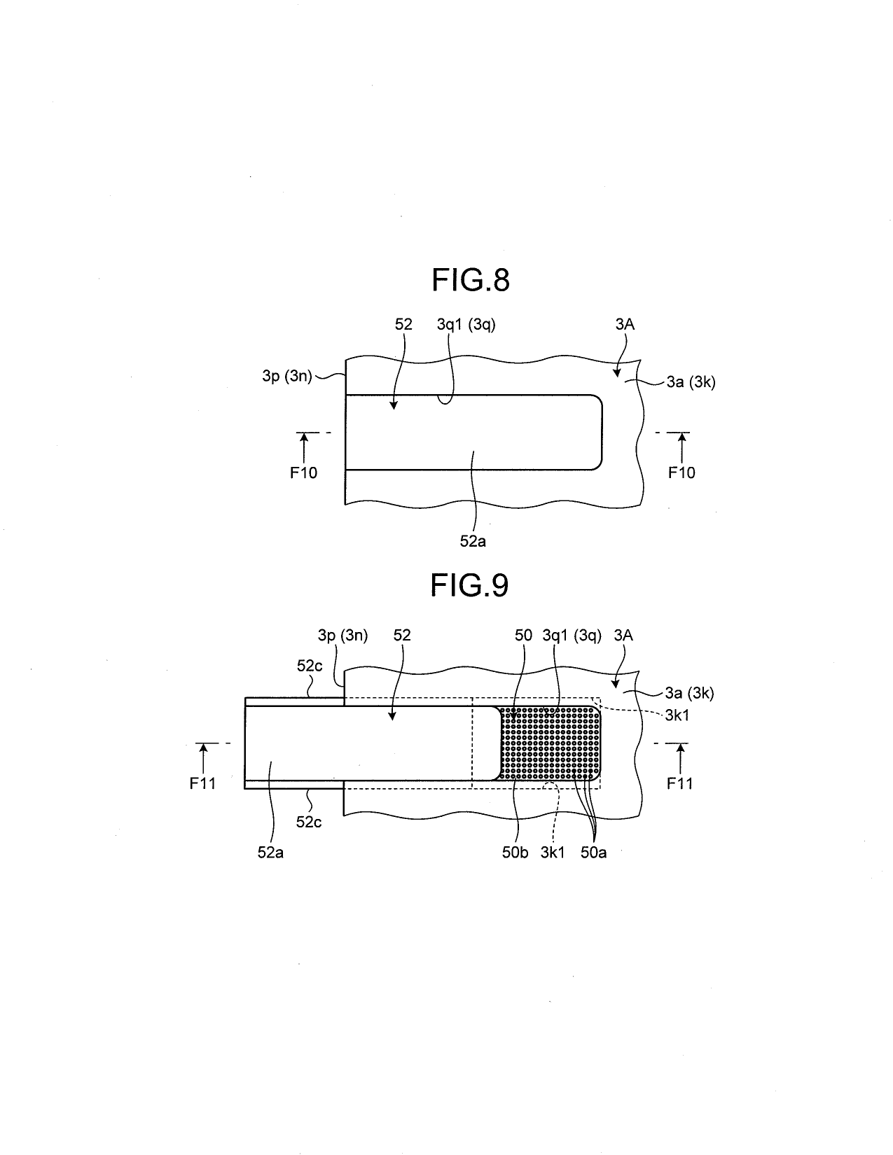

Next, the second modification of the first embodiment will be described with reference to FIG. 8 and FIG. 9. In the second modification, the contact member 52 is slidable relative to the cover 50. The cover 50 of the second modification does not have the plate portion 50b. The cover 50 is constituted by the plate portion 50a, and has a tabular form. The contact member 52 does not have the plate portion 52b. The contact member 52 is constituted by the plate portion 52a, and has a tabular form.

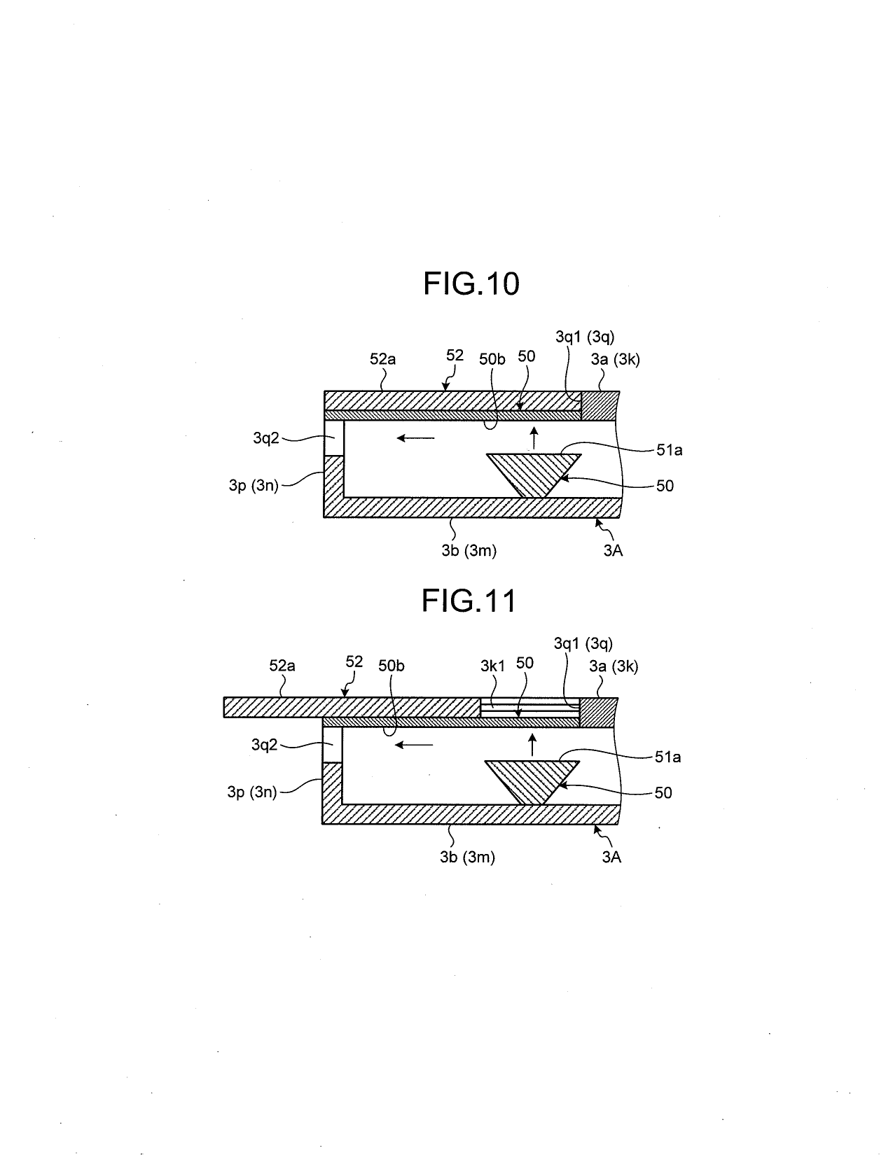

On the opening face (hole face) of the opening 3q on the wall 3k, gap portions 3k1 (engaging portions, concave portions) are provided. On the contact member 52, convex portions 52c (engaging portions) engaged with the gap portions 3k1 in a slidable manner are provided. With such arrangement, the contact member 52 is slidable relative to the cover 50. The contact member 52 is slidable between a close position (a position, a first position, FIGS. 8 and 10) at which the first portion 3q1 of the opening 3q provided on the wall 3k is covered and an open position (a position, a second position, FIGS. 9 and 11) at which the first portion 3q1 of the opening 3q is exposed. That is, the contact member 52 is capable of opening and closing the first portion 3q1 of the first opening 3q provided on the wall 3k. The contact member 52 is in contact with the cover 50, and is slidable (moves in sliding manner) while being contact with the cover 50.

With the above arrangement, when the contact member 52 is slid to a close position to close the first portion 3q1 of the opening 3q, it is possible to emit sound from the speaker 50 intensively from the second portion 3q2 of the opening 3q. Moreover, when the contact member 52 is slid to a close position to close the first portion 3q1 of the opening 3q, it is possible to prevent the entrance of dust, etc., into the housing 3A through the first portion 3q1 of the opening 3q. When the contact member 52 is slid to an open position, it is possible to emit sound from the speaker 50 from both of the first portion 3q1 and the second portion 3q2 of the opening 3q. Thus, in the second modification, it is possible to adjust a sound emitting direction.

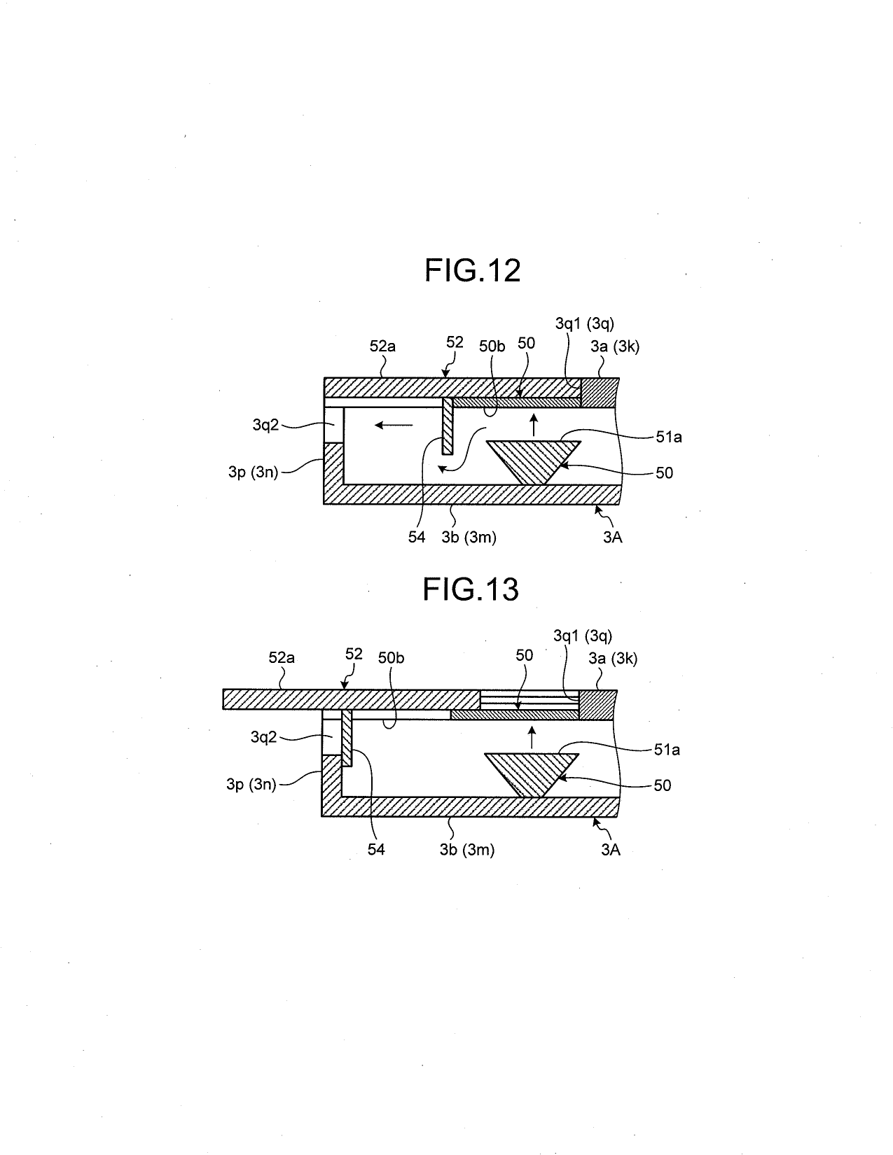

Next, the third modification of the first embodiment will be described with reference to FIGS. 12 and 13. The third modification is basically the same as the second modification. However, the third modification is different from the second modification in that the contact member 52 is provided with a lid member 54 (a shutter member, a wall member).

The lid member 54 is fixed on a face on the side of the wall 3m of the contact member 52. The lid member 54 is capable of opening and closing the second portion 3q2 of the opening 3q. When the contact member 52 is slid to a close position (FIG. 12), the lid member 54 separates from the inner face of the wall 3n to open the second portion 3q2 of the opening 3q. Thus, the sound from the speaker 50 is emitted intensively from the second portion 3q2 of the opening 3q. When the contact member 52 is slid to an open position (FIG. 13), the lid member 54 becomes in contact with the inner face of the wall 3n to close (cover) the second portion 3q2 of the opening 3q. Thus, the sound from the speaker 50 is emitted intensively from the first portion 3q1 of the opening 3q.

### Second Embodiment

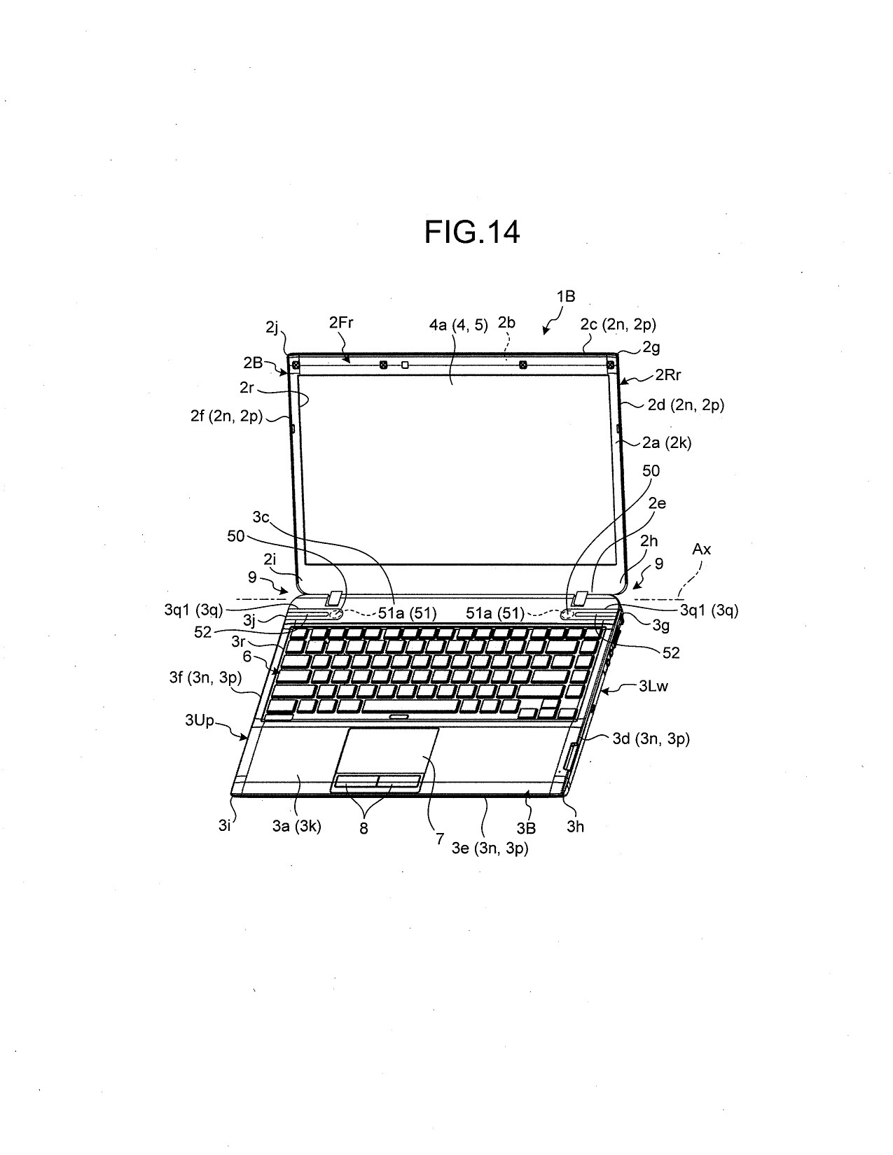

An electronic apparatus 1B of the second embodiment is a so-called laptop personal computer, for example. In the second embodiment, as an example, the electronic apparatus 1B comprises a first housing 3B (a housing), and a second housing 2B (another housing), as illustrated in FIG. 14. The first housing 3B (a first portion) houses a board (not shown). The second housing 2B (a second portion) houses at least a part of the display device 4. The first housing 3B is provided with a keyboard 6 (an input operation portion, an input receiving portion, an input portion), a touch pad 7 (an input operation portion, an input receiving portion, an input portion), click buttons 8 (input operation portions, input receiving portions, input portions), etc.

The first housing 3B and the second housing 2B are connected to each other in a rotatable manner with a hinge portion 9 (a connecting portion, a coupling portion, a rotatable support portion, a hinge mechanism, a connecting mechanism, a coupling mechanism, a rotatable support mechanism). The first housing 3B and the second housing 2B are connected to each other in a rotatable manner with the hinge portion 9 at least between an open state illustrated in FIG. 14 and a close state (not shown). In the second embodiment, as an example, the hinge portion 9 connects the first housing 3B and the second housing 2B in a rotatable manner around a rotation axis Ax. The display screen 4a of the display device 4 is exposed through an opening 2r provided on a face 2a (a front face, a face, a face portion) of the second housing 2B. The keyboard 6, the touch pad 7, the click buttons 8, etc., are exposed on a face 3a (an upper face, a front face, a first face, a first face portion) of the first housing 3B. In the close state, the face 3a of the first housing 3B and the face 2a of the second housing 2B are overlapped each other, and the display screen 4a, the keyboard 6, the touch pad 7, the click buttons 8, etc., are hidden by the first housing 3B and the second housing 2B. In the open state, the face 3a of the first housing 3B and the face 2a of the second housing 2B are exposed, and the display screen 4a, the keyboard 6, the touch pad 7, the click buttons 8, etc., become available (visually recognizable or operational).

The second housing 2B is rectangular (oblong as an example in the second embodiment) in a front view and a rear view. In the second embodiment, as an example, the second housing 2B is thin flat rectangular parallelepiped in a front-back direction (a thickness direction of the second housing 2B). The second housing 2B has the face 2a, and the opposite rear face (a face, a back face, a rear face, a face portion). The face 2a and the rear face are nearly parallel (parallel in the second embodiment as an example). The second housing 2B has four ends 2c to 2f (sides, edges), and four corners 2g to 2j (apexes, curves, ends) in a front view. The ends 2c and 2e are examples of long sides, while the ends 2d and 2f are examples of short sides.

The second housing 2B has a wall 2k (a portion, a plate, a frame, a front wall, a surface wall, a top wall) having the face 2a, and a wall opposite to the wall 2k (a wall having a rear face, a portion, a plate, a back wall, a rear wall, a bottom wall). The wall 2k and the wall having the rear face are rectangular (oblong as an example in the second embodiment). The wall 2k has a frame form, and the wall opposite to the wall 2k has a plate form. The second housing 2B has four walls 2n (portions, plates, side walls, end walls, standing walls, extending portions) that have a face 2p (a side face, a peripheral face) extending between the wall 2k and the wall opposite to the wall 2k. The rectangular opening 2r is provided on the wall 3k.

The second housing 2B is constituted by a combination of a plurality of parts (split bodies, members). As an example, the second housing 2B comprises a first member 2Fr (a first portion, a front-side member, a cover, a bezel, a frame) having at least the wall 2k, and a second member 2Rr (a second portion, a back-side member, a base, a bottom, a plate, a cover) having at least the wall opposite to the wall 2k (a wall having a rear face). In the second embodiment, as an example, the walls 2n are constituted as a part of the second member 2Rr. The first member 2Fr, the second member 2Rr, etc., can be individually formed of metallic, synthetic resin, or other material.

In the second embodiment, as an example, the second housing 2B houses the display device 4 (a display portion, a display, a panel, a display part). Concretely, the display screen 4a positioned on the side of the face 2a of the display device 4 is exposed to the front side (outside) of the second housing 2B through the opening 2r. A user can visually recognize the display screen 4a through the opening 2r from the front side. The display device 4 is rectangular (oblong as an example in the second embodiment) in a front view. The display device 4 is thin flat rectangular parallelepiped in a front-back direction. The display device 4 is an LCD, an GELD, or a PDP, for example.

In the second embodiment, as an example, on the front side (the surface side, the side of the wall 2k) of the display device 4, the transparent relatively-thin rectangular input operation panel 5 (a touch panel, a touch sensor, an operation face, an input operation portion, an input receiving portion, for example) is provided. The input operation panel 5 covers the display screen 4a. An operator (a user, for example) touches, pushes, rubs the input operation panel 5 with a finger or a stylus, etc., or moves a finger or a stylus, etc., in the vicinity of the input operation panel 5, for example, so as to perform input processing. The light emitted from the display screen 4a of the display device 4 passes through the input operation panel 5, and is then let out to the front side (outside) of the second housing 2B through the opening 2r on the wall 2k. The input operation panel 5 is an example of an input module. In the second embodiment, the display device 4 and the input operation panel 5 are fixed to (supported by) one of the first member 2Fr and the second member 2Rr with fixtures (fixing components, metal fittings (screws, metal fittings, parts, etc.)) (not shown) or with an adhesive joint (adhesives, a double sided tape, etc.) (not shown), for example.

In the second embodiment, as an example, the first housing 3B is rectangular (oblong as an example in the second embodiment) in a front view and a rear view. In the second embodiment, as an example, the first housing 3B is thin flat rectangular parallelepiped vertically (in a thickness direction of the first housing 3B). The first housing 3B has the face 3a (an upper face, a front face, a face portion), and the opposite rear face (a face, a lower face, a rear face, a face portion). The face 3a and the rear face are nearly parallel (parallel in the second embodiment as an example). The first housing 3B has four ends 3c to 3f (sides, edges), and four corners 3g to 3j (apexes, curves, ends) in a planar view. The ends 3c and 3e are examples of long sides, while the ends 3d and 3f are examples of short sides. The first housing 3B can function as a housing portion for housing parts (the speaker 51, for example), and also as a support for supporting heavy objects (parts, etc.), for example.

The first housing 3B has the wall 3k (a portion, a plate, a frame, an upper wall, a surface wall, a top wall) having the face 3a, and a rear wall having a rear face (a wall, a portion, a plate, an lower wall, a rear wall, a bottom wall). The wall 3k and the rear wall having the rear face are rectangular (oblong as an example in the second embodiment). The wall 3k has a frame form, and the wall 3m has a plate form. The first housing 3B has four walls 3n (portions, plates, side walls, end walls, standing walls, extending portions) that have a face 3p (a side face, a peripheral face) extending between the wall 3k and the rear wall. The rectangular opening 3r is provided on the wall 3k.

The first housing 3B is constituted by a combination of a plurality of parts (split bodies, members). As an example, the first housing 3B comprises a first member 3Up (a first portion, an upper member, a cover, a mask, a frame) having at least the wall 3k, and a second member 3Lw (a second portion, a lower member, a base, a bottom, a plate, a cover) having at least the rear wall. In the second embodiment, as an example, the walls 3n are constituted as apart of the second member 3Lw. Separately from the first member 3Up and the second member 3Lw, the first housing 3B can comprise a third member (a third portion, an intermediate member, an inner, a middle frame, a middle plate) (not shown), which is interposed between the first member 3Up and the second member 3Lw. A part of the third member can constitute a part of the walls 3k, 3m, and 3n. The first member 3Up, the second member 3Lw, the third member, etc., can be individually formed of metallic, synthetic resin, or other material.

In the second embodiment, as an example, the first housing 3B houses one or more boards (a circuit board, a control board, a main board, an electrical part). The board is provided in nearly parallel (parallel in the second embodiment as an example) with the keyboard 6.

In the second embodiment, as an example, a plurality of parts (not shown) such as a CPU, a graphic controller, power circuit parts, a PCH, a memory slot connector, an LCD connector, an I/O connector, a power coil, an element, and a connector, can be mounted on the board. A control circuit can comprise an image signal processing circuit, a tuner, an HDMI signal processor, an AV input terminal, a remote control signal receiving module, a controller, a selector, an on-screen display interface, a memory (a ROM, a RAM, an HDD, or an SSD, for example), a voice signal processing circuit, etc. The control circuit controls the output of images (moving images, still images, etc.) on the display screen 4a of the display device 4, the output of voice from the speaker 51, the emission of light from an LED (not shown), etc. The display device 4, the speaker 51, and the LED are examples of an output module.

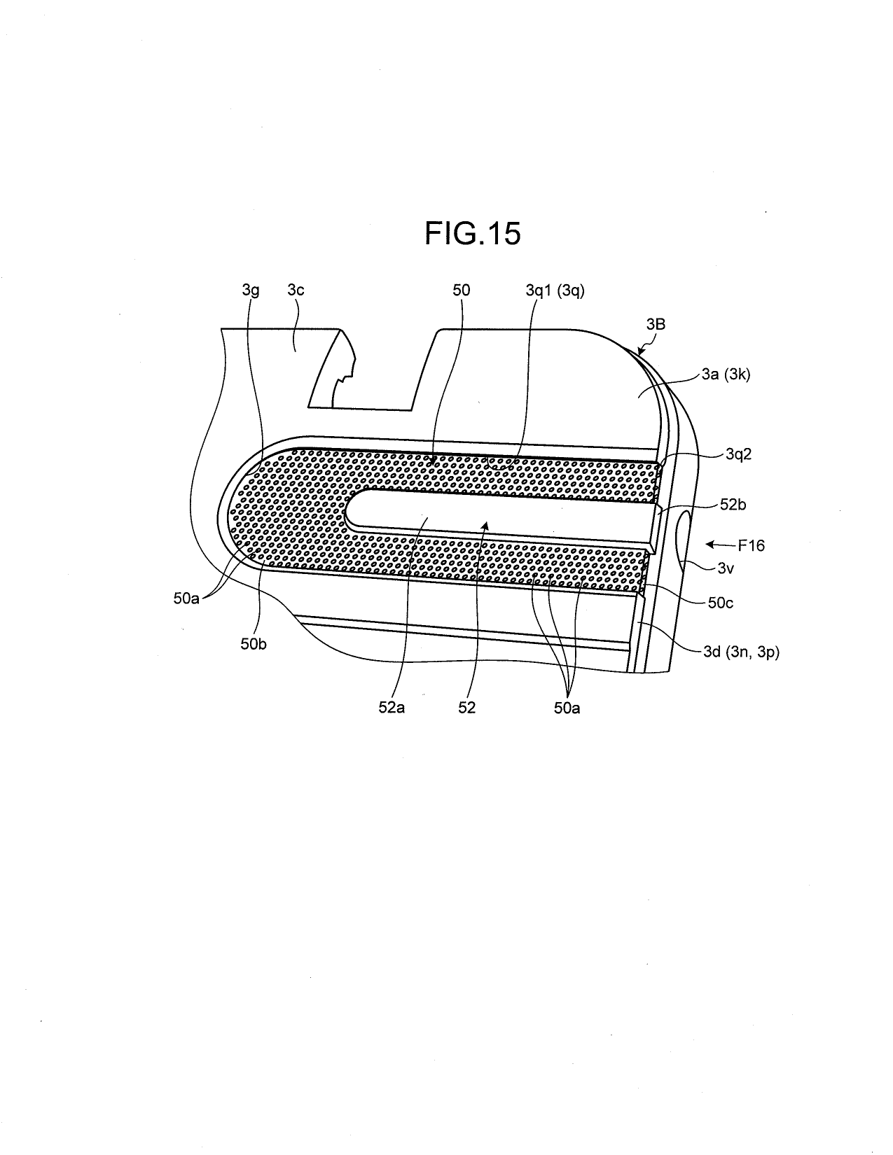

As illustrated in FIGS. 14 and 15, the wall 3k is provided with the left-and-right pair of openings 3q. The opening 3q is an example of the first opening. The two opening 3q are provided in a longitudinal direction of the display screen 4a with mutual space. On each of the openings 3q, the cover 50 having the openings 50a is provided. The opening 50a is an example of the second opening. Behind the area at which the opening 3q (the openings 50a of the cover 50) is provided, the speaker 51 (see FIG. 5, a housed part) is provided, and voice (sound) emitted from the sound emitting portion 51a (a sound emitting face, an emitting portion, an emitting face) of the speaker 51 is output through the opening 3q (the cover 50).

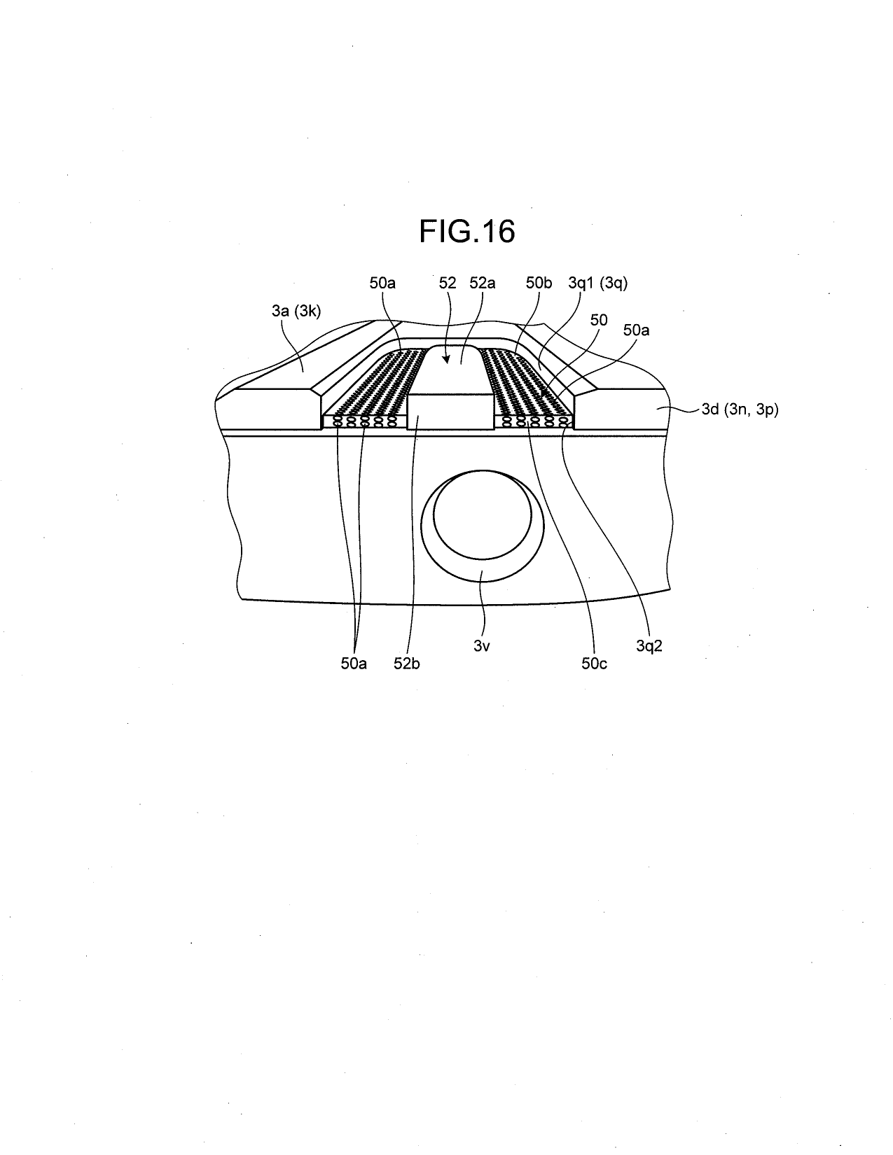

To be more specific, as illustrated in FIGS. 14 to 16, the opening 3q is provided so as to extend between the wall 3k (a first wall) and the wall 3n (a second wall). Thus, the opening 3q has the first portion 3q1 (a portion) provided on the wall 3k, and the second portion 3q2 (a portion) provided on the wall 3n. Here, the wall 3k is an example of the first wall, and the wall 3n is an example of the second wall connected, at an angle, to the wall 3k (a first wall).

The speaker 51 is housed in the first housing 3B at a position at which the speaker 51 is exposed through the opening 3q. As an example, the speaker 51 is housed in the first housing 3B at a position at which the speaker 51 is exposed through the first portion 3q1 of the opening 3q. The speaker 51 emits sound to the outside of the first housing 3B through the openings 3q. In the speaker 51, the sound emitting portion 51a faces the first portion 3q1 of the opening 3q. The speaker 51 is fixed onto the wall 3k, for example. As an example, the speaker 51 comprises a housing 51b, and the sound emitting portion 51a exposed on the housing 51b, as illustrated in FIG. 19. The housing 51b is provided with a guiding portion 51c extending from the sound emitting portion 51a. An elastic member 51d is fixed on the housing 51b. The elastic member 51d and the guiding portion 51c guide the sound emitted from the sound emitting portion 51a to the opening 3q. The elastic member 51d and the guiding portion 51c form an acoustic space. As an example, the speaker 51 is fixed to the wall 3k with a fixing member 55. The fixing member 55 supports the hinge portion 9.

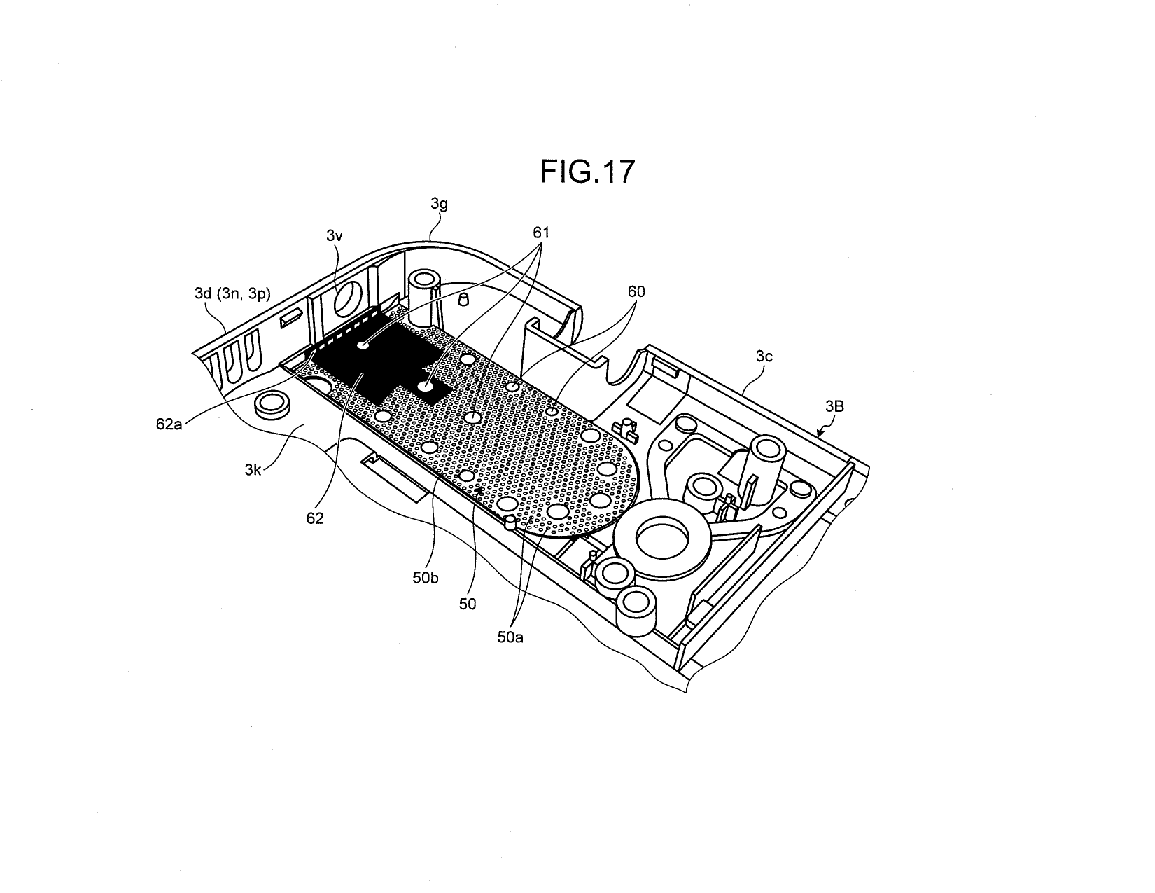

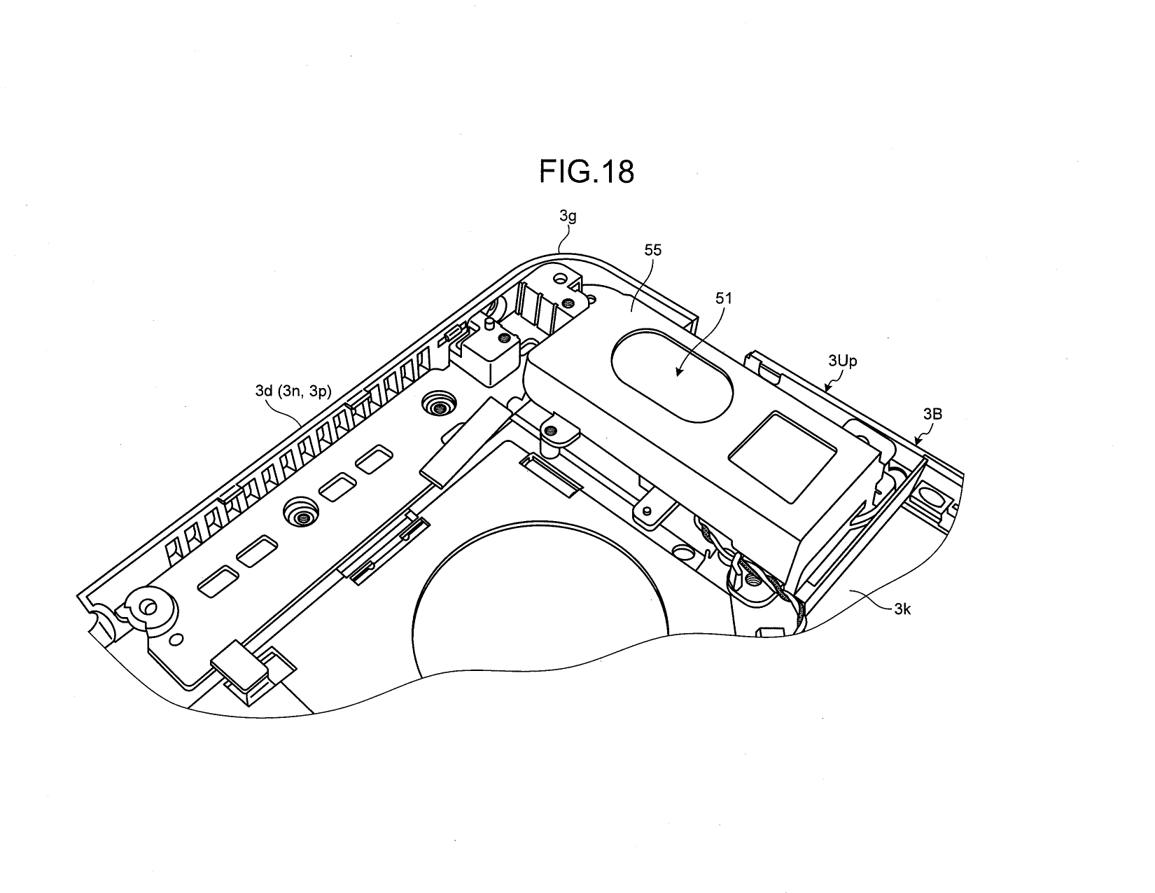

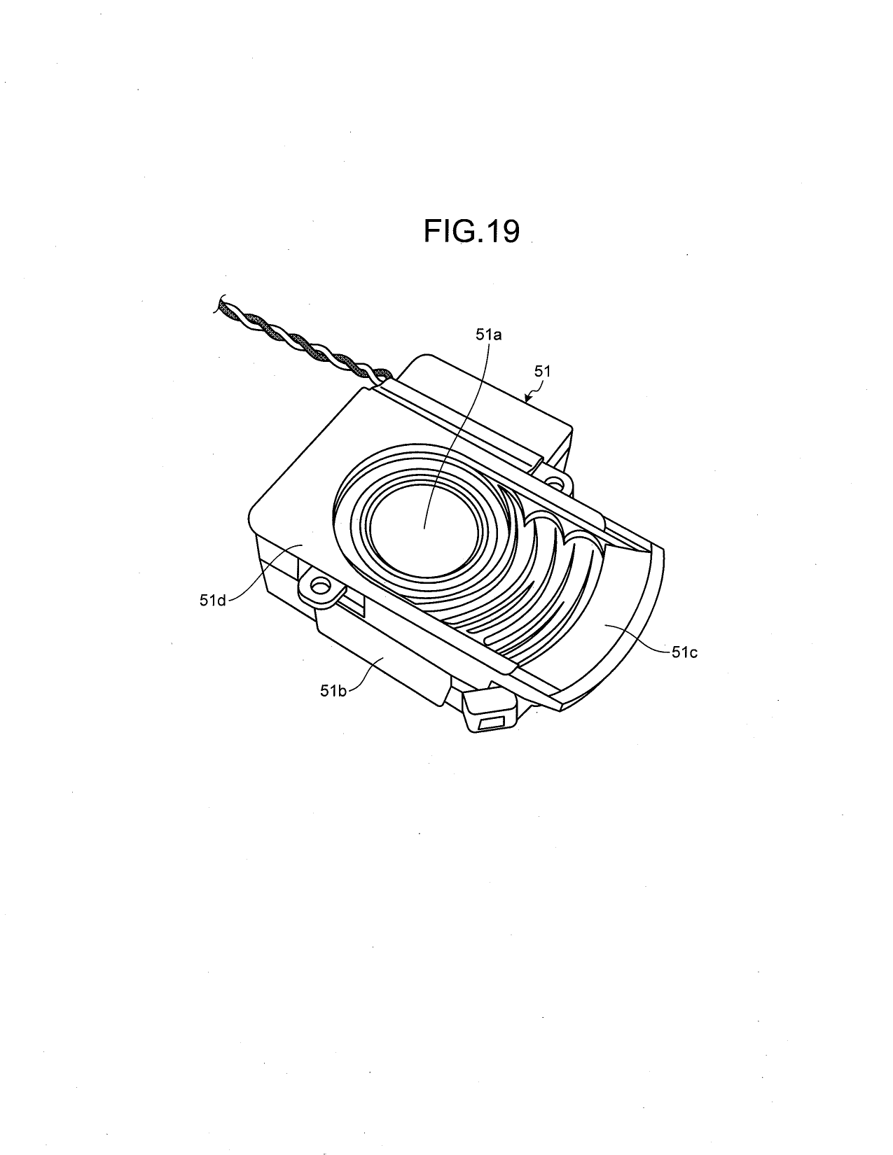

The covers 50 are constituted as schematic net-formed plates, for example, as illustrated in FIGS. 15 to 17. The covers 50 have a schematic L-form. The covers 50 are provided on the openings 3q. As an example, at least a part of the cover 50 is positioned in the opening 3q. The covers 50 are fixed onto the housing 3A with fixing portions 60 (FIG. 17) by caulking, adhesion, welding, or other method. To be more specific, the cover 50 has the plate portion 50b (a first portion, a first plate portion, a wall), and the plate portion 50c (a second portion, a second plate portion, a wall) bended relative to the plate portion 50b. The plate portion 50b is positioned on the wall 3k. The plate portion 50b is provided on the first portion 3q1 of the opening 3q, and is fixed onto the wall 3k. The plate portion 50c is connected, at an angle, to the first portion, and positioned on the wall 3n. The plate portion 50c is provided on the second portion 3q2 of the opening 3q, and is fixed onto the wall 3n. That is, the covering member 50 is arranged so as to extend between the wall 3k and the wall 3n.

The cover 50 covers the speaker 51. To be more specific, the plate portion 50b faces the sound emitting portion 51a of the speaker 51. The cover 50 is provided with the openings 50a entirely. In other words, each of the plate portions 50b and 50c is provided with the openings 50a. The cover 50 can be formed of metal, or resin, for example. As illustrated in FIG. 17, a plate member 62 is fixed on a part of the rear face of the contact member 52. The plate member 62 is provided with openings 62a in communication with the openings 50a.

The cover 50 is provided with the contact member 52 (a part, a member). The contact member 52 has a form along the cover 50. That is, the contact member 52 is constituted by a schematic L-form plate. To be more specific, the contact member 52 has the plate portion 52a (a first portion) provided in contact with the plate portion 50b, and the plate portion 52b provided in contact with the plate portion 50c. At least a part of the contact member 52 is positioned on the side of the cover 50 opposite to the speaker 51. The contact member 52 is provided in contact with the cover 50 so as to cover a part of the openings 50a. The opening 50a may not be provided on an area in the cover 50 at which the contact member 52 is provided (an area that overlaps with the contact member 52). The contact member 52 is fixed onto the cover 50 with fixing portions 61 by caulking, adhesion, welding, or other method. A logo or the like may be put on the surface of the contact member 52. As an example, the contact member 52 is positioned in the vicinity of an opening 3v provided on the wall 3n.

In the second embodiment, as an example, the second housing 2B (a movable body) is connected to the first housing 3B in a rotatable manner between a position at which the portion 3q1 of the opening 3q provided on the wall 3k is covered and another position at which the portion 3q1 is exposed. Thus, it is possible to adjust a sound emitting direction by displacing the second housing 2B (a movable body).

As described above, the electronic apparatus 1B in the second embodiment has a structure relating to the contact member 52 same as in the television receiver 1A in the first embodiment. Therefore, also in the second embodiment, the same results as in the first embodiment can be obtained. As the contact member 52, the contact member in each of the modifications described in the first embodiment may be applied.

In this way, in each of the embodiments and the modifications that are described above, it is possible to prevent the occurrence of noises from the cover 50.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television receiver comprising:
a housing comprising a first opening;
a speaker configured to be housed in the housing at a position where the speaker is exposed through the first opening;
a cover comprising a plurality of second openings, the cover configured to be fixed to the housing on the first opening to cover the speaker; and
a contact member in contact with the cover and configured to cover a part of the second openings.

2. The television receiver of claim 1, wherein the contact member is configured to be fixed to the cover.

3. The television receiver of claim 1, wherein the contact member is configured to be fixed to the housing.

4. The television receiver of claim 1, wherein
the housing comprises a first wall, and a second wall connected, at an angle, to the first wall,
the first opening is configured to extend between the first wall and the second wall, and
the cover comprises a first portion comprising the second openings, the first portion configured to be at the first wall, and a second portion comprising the second openings, the second portion configured to be connected, at an angle, to the first portion, and at the second wall.

5. The television receiver of claim 1, wherein the contact member is configured to be slidable relative to the cover.

6. The television receiver of claim 5, wherein
the housing comprises a first wall, and a second wall connected, at an angle, to the first wall,
the first opening is configured to extend between the first wall and the second wall,
the cover comprises a first portion comprising the second openings, the first portion configured to be positioned at the first wall, and a second portion comprising the second openings, the second portion configured to be connected, at an angle, to the first portion, and at the second wall, and
the contact member is configured to open and close a portion of the first opening at the first wall.

7. The television receiver of claim 4, further comprising a movable body connected to the housing in a movable manner between a position at which a portion of the first opening at the first wall is covered and another position at which the portion is exposed.

8. The television receiver of claim 1, wherein at least a part of the contact member is configured to be at a side of the cover opposite to the speaker.

9. The television receiver of claim 1, wherein the contact member is a plate.

10. An electronic apparatus comprising:
a housing comprising a first opening;
a speaker configured to be housed in the housing and to emit sound through the first opening;
a cover comprising a plurality of second openings, the cover configured to be fixed to the housing on the first opening; and
a contact member configured to be in contact with the cover.
